(19) United States
(12) Patent Application Publication
(10) Pub. No.: US 2016/0121285 A1
(43) Pub. Date: May 5, 2016

(54) Apparatus for Mixing Solid Particles and Fluids

(71) Applicant: SCHLUMBERGER TECHNOLOGY CORPORATION, Sugar Land, TX (US)

(72) Inventors: Hau Nguyen-Phuc Pham, Houston, TX (US); Noriko Yao, Sugar Land, TX (US)

(21) Appl. No.: 14/531,169

(22) Filed: Nov. 3, 2014

(51) Int. Cl. B01F 15/02; B01F 7/00; B01F 3/12

(52) U.S. Cl. CPC B01F 15/0235; B01F 3/1207; B01F 3/1221; B01F 7/00341

(57) ABSTRACT

An apparatus that includes a casing having an outer layer and an inner layer, a hopper, a rotary drive, a slinger, an impeller, an inlet, and an outlet. The hopper is operable for delivering bulk solids into the casing. The inlet is operable for delivering fluid into the casing. The outlet is operable for discharging a mixture of the bulk solids and the fluid from the casing. The rotary drive is disposed external to the casing, and the slinger is suspended for rotation within the casing via a drive extension extending from the rotary drive into the casing. The impeller is coupled with the slinger within the casing.

### BACKROUND OF THE DISCLOSURE

Solid particles may be mixed with a fluid by using a mixing apparatus in which solid particles, such as sand, sand-like particles, or other solid particles, are mixed or blended with a fluid, such as a fluid composition, gel, water, or other fluid. As the solid particles and the fluid are mixed, the resulting solid/fluid mixture, sometimes referred to as a slurry, is pressurized and forced out through an outlet in the mixing apparatus.

During operation of the mixing apparatus, the solid particles flow out of a hopper in a substantially continuous stream and drop onto a rotating slinger through an upper inlet opening in a casing, which houses the slinger. An impeller, which is connected with and rotates at the same speed as the slinger, creates air suction that draws the fluid into the casing through a lower inlet opening. As the fluid is pulled into the casing, it is pressurized by the impeller and mixed with the solid particles, which are being flung radially outwards from the slinger in a centrifugal action. The solid/fluid mixture is then continuously discharged, under pressure, through an outlet in the casing.

Due to the abrasive properties of certain solid particles, portions of the mixing apparatus that are exposed to these solid particles and/or the solid/fluid mixture may be eroded and the life cycle of the mixing apparatus reduced. For example, the solid particles travel at high speeds within the casing, and are thus forced into contact with certain interior portions of the casing, causing erosion at the points of contact. Furthermore, because of the restricting nature of the casing outlet, increased slurry pressure and velocity is generated at the outlet, resulting in the solid particles making contact with the walls of the outlet with increased force, which also causes erosion. Also, as the ratio of solid particles to fluid increases, the casing may be eroded at an increased rate.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces an apparatus that includes a casing having an outer layer and an inner layer, a hopper for delivering bulk solids into the casing, and a rotary drive disposed external to the casing. A slinger is suspended for rotation within the casing via a drive extension extending from the rotary drive into the casing. An impeller is coupled with the slinger within the casing. The apparatus also includes an inlet for delivering fluid into the casing, and an outlet for discharging a mixture of the bulk solids and the fluid from the casing.

The present disclosure also introduces a method that includes assembling a mixing apparatus by providing a casing comprising an upper section and a lower section that comprise a first material, covering at least portions of each of the upper and lower sections of the casing with a second material, and coupling the upper section of the casing and a hopper such that the upper section is disposed below the hopper. A rotary drive and a drive extension are then coupled, and the drive extension is extended through an opening in the upper section of the casing. A slinger and an impeller are also coupled such that the impeller is disposed below the slinger. At least one of the slinger and impeller is coupled with the drive extension, and the upper section of the casing and the lower section of the casing are coupled to enclose the slinger and the impeller within the casing.

The present disclosure also introduces a method that includes replacing portions of a mixing apparatus by uncoupling an upper section of a casing from a central section of the casing, removing a used upper wear plate from between the upper section of the casing and the central section of the casing, and inserting a replacement upper wear plate between the upper section of the casing and the central section of the casing. The method also includes coupling the upper section of the casing and the central section of the casing, uncoupling a lower section of the casing from the central section of the casing, and removing a used lower wear plate from between the lower section of the casing and the central section of the casing. The method also includes inserting a replacement lower wear plate between the lower section of the casing and the central section of the casing, and coupling the lower section of the casing and the central section of the casing.

These and additional aspects of the present disclosure are set forth in the description that follows, and/or may be learned by a person having ordinary skill in the art by reading the materials herein and/or practicing the principles described herein. At least some aspects of the present disclosure may be achieved via means recited in the attached claims.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a sectional side view of at least a portion of apparatus according to one or more aspects of the present disclosure.

FIG. 2 is a partial sectional view of a portion of the apparatus shown in FIG. 1.

FIG. 3 is an isometric view of an example implementation of a portion of the apparatus shown in FIGS. 1 and 2.

FIG. 4 is a sectional view of the apparatus shown in FIG. 3 with additional components.

FIG. 5 is an isometric view of an example implementation of a portion of the apparatus shown in FIGS. 1 and 2.

FIG. 6 is a sectional view of the apparatus shown in FIG. 5.

FIG. 7 is an isometric sectional view of the apparatus shown in FIGS. 5 and 6.

FIG. 8 is an exploded view of a portion of the apparatus shown in FIGS. 5-7.

FIG. 9 is an isometric sectional view of another example implementation of the apparatus shown in FIG. 7.

FIG. 10 is a flow-chart diagram of at least a portion of a method according to one or more aspects of the present disclosure.

FIG. 11 is a flow-chart diagram of at least a portion of a method according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

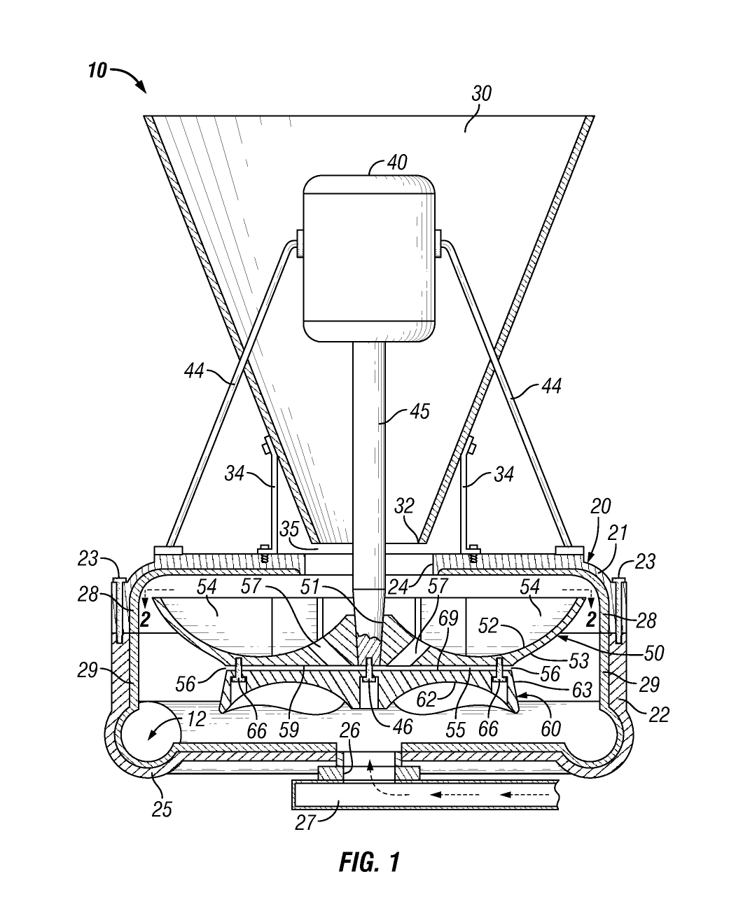

FIG. 1 is a sectional side view of at least a portion of apparatus according to one or more aspects of the present disclosure. In particular, FIG. 1 shows a mixing apparatus 10 comprising a hopper 30, such as may contain solid particles (not shown) like sand, other sand-like particles, propping agents, and/or other solid particles. The mixing apparatus 10 further comprises a casing 20 (i.e., a housing), such as may receive therein the solid particles from the hopper 30 and a fluid (not shown) from an inlet 26 and conduit 27. The solid particles and fluid are mixed in the casing 20 to form a solid/fluid mixture or “slurry” (not shown). The casing 20 may comprise an upper section 21 coupled with a lower section 22, whether via one or more threaded fasteners 23 and/or other means.

The casing 20 may comprise an additional layer of material about its inner surface, wherein the inner layer may be operable to resist abrasion and/or erosion caused by the solid particles during mixing operations, such as to increase the functional life of the casing 20. For example, the upper section 21 of the casing 20 may be covered with an upper inner layer 28 of material and the lower section 22 of the casing 20 may be covered with a lower inner layer 29 of material, such that the upper and lower sections 21, 22 may be considered as an outer layer of the casing 20. The material forming the upper and the lower sections 21, 22 of the casing 20 may comprise a first material, while the material forming the upper and lower inner layers 28, 29 of the casing 20 may comprise a second material. For example, the second material may be resistant to abrasion, may be more resistant to abrasion than the first material, and/or may be substantially harder than the first material. For example, the first material may have a hardness ranging between about 205 BHN (Brinell Hardness Number) and about 235 BHN, and the second material may have a hardness greater than about 600 BHN. However, other hardnesses are also within the scope of the present disclosure. The second material may also or instead comprise nanomaterial, such as may have a feature or character having at least one dimension that is less than about 100 nanometers.

The upper and lower inner layers 28, 29 of the second material may be clad onto the upper and the lower sections 21, 22 of the casing 20, respectively. For example, the upper and lower inner layers 28, 29 may be formed by thermal spraying the second material onto the surface of the upper and the lower sections 21, 22 of the casing 20, such as where the second material may be melted or heated and sprayed onto the surface of the casing 20. The upper and lower inner layers 28, 29 may also or instead be formed by hot-melt-coating the second material onto the surface of the upper and the lower sections 21, 22 of the casing 20, respectively. For example, the second material in the form of a cored wire, a stick electrode, or a powder may be melted onto the inner surface of the casing sections 21, 22. The upper and lower inner layers 28, 29 and the upper and the lower sections 21, 22 may also or instead be welded together. In these and other example implementations within the scope of the present disclosure, the thickness of the upper and lower inner layers 28, 29 may range between about two millimeters and about seven millimeters. However, other thicknesses are also within the scope of the present disclosure.

The hopper 30 may be mounted above the casing 20 by one or more vertical supports 34. The bottom end of the hopper 30 may comprise an outlet opening 32 that terminates at or just above an inlet opening 24 of the casing 20, such as in a manner permitting solid particles to be continuously dropped from the hopper 30 into the casing 20. Disposing the outlet opening 32 of the hopper 30 just above the inlet opening 24 of the casing may provide an exterior air exhaust space 35 between the hopper 30 and the inlet opening 24, such as may permit air or other gasses located between and/or within the solid particles to vent from the casing 20. However, the ability to vent air or other gasses out of the casing 20 may be provided by other means, such as a vent tube (not shown) that may extend through the wall of the hopper 30 and downward through the inlet opening 24. When such venting means are utilized, the hopper 30 may abut against the inlet opening 24, such that the exhaust space 35 is minimized or eliminated.

The mixing apparatus 10 may further comprise a drive shaft or another drive extension 45 extending into the casing 20 through the inlet opening 24, including extending through the upper section 21 and the upper inner layer 28 of the casing 20. The drive extension 45 may be driven by a motor or another rotary drive 40 operatively coupled with the drive extension 45. The rotary drive 40 may be maintained in position by one or more vertical supports 44, such as may be fastened to the upper section 21 of the casing 20 and/or to other portions of the mixing apparatus 10.

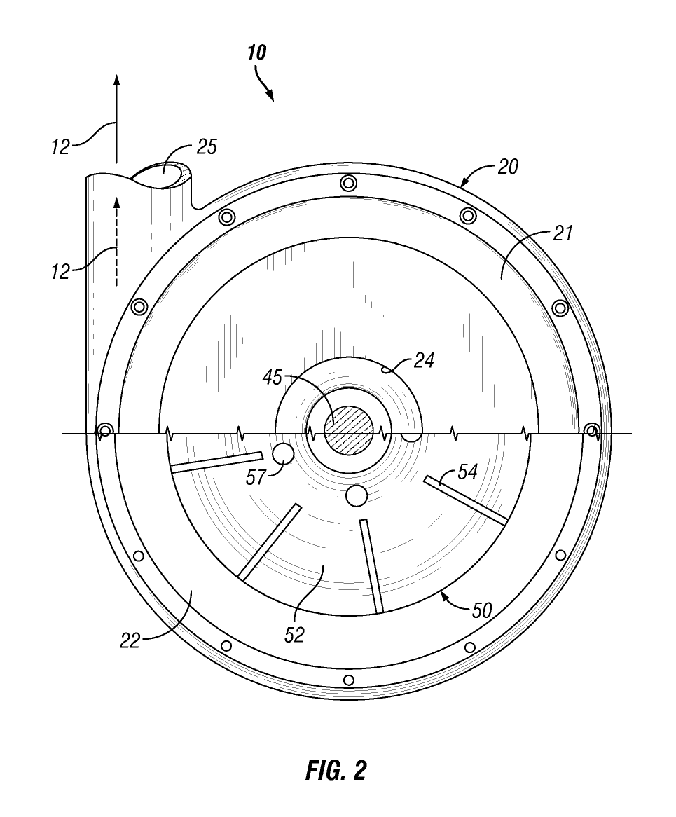

FIG. 2 is a top, partial-sectional view of a portion of an implementation of the mixing apparatus 10 shown in FIG. 1 according to one or more aspects of the present disclosure. Referring collectively to FIGS. 1 and 2, the mixing apparatus 10 further comprises a slinger 50 and an impeller 60 disposed within the casing 20. An upper surface 52 of the slinger 50 may have a toroidal concave configuration facing the upper section 21 of the casing 20. The concave surface 52 of the slinger 50 may comprise thereon a plurality of upstanding, radially outwardly extending blade members 54. The bottom side of the slinger 50 may comprise a flat or otherwise shaped face 59, which may match a corresponding flat or otherwise shaped face 69 on the upper side of the impeller 60. The slinger 50 may be coupled or otherwise fixedly connected to the impeller 60 to rotate synchronously therewith. The slinger 50 may be connected to the impeller 60 at their faces 59, 69 by one or more threaded fasteners 66 and/or other means. The slinger 50 and the impeller 60 are shown axially spaced apart, such as to define an exhaust space 55 between the face 59 of the slinger 50 and the face 69 of the impeller 60. The exhaust space 55 may be operable to exhaust gas therethrough, and a radially outer portion 56 of the exhaust space 55 may be operable as an air or gas inlet into the exhaust space 55. The slinger 50 may further comprise exhaust channels 57, which may extend diagonally or otherwise through the body of the slinger 50. For example, the exhaust channels 57 may extend between the face 59 and the concave surface 52 of the slinger 50, such as may permit air or gas to communicate from the exhaust space 55 to the space between the slinger 50 and the inlet opening 24. The slinger 50 may further comprise an outer side 53 having a radially inward downward sloping surface, which terminates at the gas inlet 56, located at the radially inward portions of the outer side 53.

The impeller 60 may comprise a concave inner surface 62 having a vortex configuration that faces toward the lower section 22 of the casing 20, such that rotation of the impeller 60 may induce air on the underside thereof to move in a vortex manner. An outer side 63 of the impeller may be a radially outward downward sloping surface.

The slinger 50 may further comprise a central opening 51 extending therethrough, such as to receive therein or therethrough the bottom end of the drive extension 45. The impeller 60 may be secured to the bottom end of drive extension 45 by one or more threaded fasteners 46 and/or other means, such as may extend through a central portion of the impeller 60 to threadedly engage the drive extension 45 and retain the impeller 60 in connection with the drive extension 45. As the slinger 50 is coupled with the impeller 60, both the slinger 50 and the impeller 60 may be coupled to the drive extension 45 and, therefore, the rotary drive 40.

The lower section 22 and the lower inner layer 29 of the casing 20 comprise an outlet 25 extending therefrom, such as may be operable for discharging the solid/fluid mixture from the casing 20. The outlet 25 may be positioned adjacent the bottom and radially outward portion of the lower section 22, and may comprise a substantially tubular configuration, whether substantially cylindrical or otherwise. The lower section 22 and the lower inner layer 29 of the casing 20 may further comprise an inlet opening 26 at their axial center. The inlet opening 26 may be fluidly connected with an inlet conduit 27, which may be in connection with a source of fluid (not shown).

During mixing operations of the mixing apparatus 10, the solid particles are mixed with the fluid to obtain a solid/fluid mixture. At the start of the mixing operations, the rotary drive 40 rotates the drive extension 45 and, therefore, rotates the slinger 50 and the impeller 60. With the slinger 50 and the impeller 60 in motion, a desired amount of solid material may be loaded into the hopper 30 such that the solid material can flow in a substantially continuous stream through the inlet opening 24 and drop onto the rotating slinger 50. As the solid material drops onto the slinger 50, it is propelled radially outward. With the impeller 60 rotating at the same speed as the slinger 50, the vortex action of the impeller 60 generates a suction force above the inlet opening 26, such as may be operable to draw the fluid from the inlet conduit 27 into the casing 20 though the inlet opening 26 and propel it radially outward.

As the fluid is pulled into the casing 20, the fluid is pressurized by the impeller 60 and mixes with the solid particles. The result is a thorough mixing of the solid particles and the fluid to form a solid/fluid mixture, which may be continuously discharged under pressure through the outlet 25, as shown by arrows 12. During the mixing operations, air trapped between the solid particles may be carried into the fluid during the mixing operations. Such trapped air may be exhausted out during the mixing operations from the radially outward portion of the casing 20 to the external atmosphere through the exhaust space 55, the exhaust channels 57, and the inlet opening 24. From the outlet 25, the solid/fluid mixture may be carried into a storage unit or a pumper unit for injection into a wellhead and borehole.

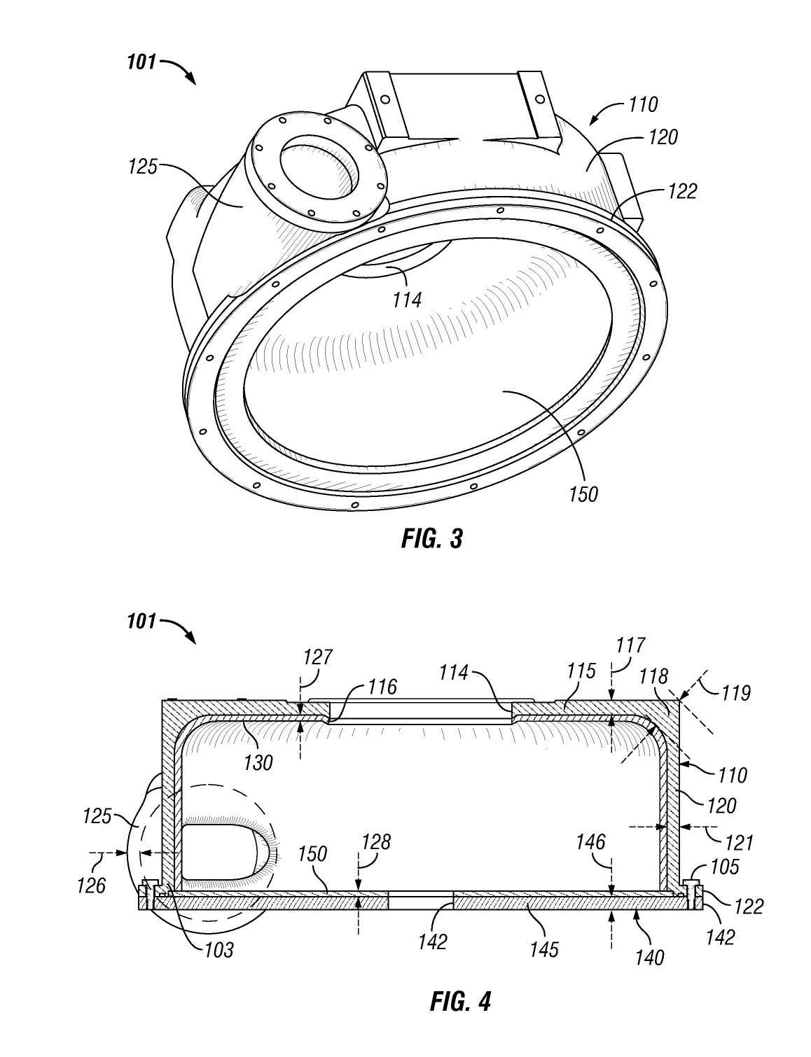

FIG. 3 is a lower isometric view of a portion of an example implementation of the casing 20 according to one or more aspects of the present disclosure, designated herein by reference numeral 101. FIG. 4 is a side sectional view of the casing 101 shown in FIG. 3. The following description refers collectively to FIGS. 3 and 4 and, where indicated by like reference numerals, FIG. 1.

The casing 101 comprises an upper section 110 and a lower section 140. The upper section 110 of the casing 101 may comprise a substantially annular disc-shaped upper wall 115 and a circumferential wall 120. The upper wall 115 is connected with the circumferential wall 120 along a junction area 118 at the upper end of the circumferential wall 120. The upper wall 115 comprises an inlet opening 114, such as may be operationally similar to the inlet opening 24 shown in FIG. 1. The inlet opening 114 may further comprise a lip 116 extending about the inlet opening 114 and into the casing 101, such as may aid in directing the solid particle supply into the casing 101 and/or preventing unwanted escape of mixture through the inlet opening 114. The outer surface of the upper wall 115 may be utilized for connection with the hopper 30 and/or the rotary drive 40, such as via the vertical supports 34, 44 shown in FIG. 1.

The circumferential wall 120 comprises an outlet 125 for discharging the solid/fluid mixture from the casing 101. The outlet 125 may comprise a substantially cylindrical or otherwise shaped tubular member extending from a lower portion of the circumferential wall 120 adjacent to an open end 103 of the circumferential wall 120. The open end 103 of the circumferential wall 120 may comprise a flange portion 122 extending thereabout, such as may be operable to connect with the lower section 140 of the casing 101.

The lower section 140 of the casing 101 may comprise a lower wall 145 and a flange portion 142, such as may be operable to connect with the flange portion 122 of the upper section 110 of the casing 101. The lower section 140 of the casing 101 comprises a centrally positioned fluid inlet 142, such as may be operationally similar to the inlet opening 26 shown in FIG. 1. The fluid inlet 142 may be operable to fluidly connect with an inlet conduit, such as the inlet conduit 27 shown in FIG. 1, which may be connected to the source of fluid (not shown). The upper section 110 may be coupled with the lower section 140 via one or more threaded fasteners 105 and/or other means. For example, the upper section 110 may be coupled with the lower section 140 by a plurality of bolts, which may extend through the flange portions 122, 142 of the upper and lower sections 110, 140, respectively.

One or more of the upper wall 115, the circumferential wall 120, the lower wall 145, and the outlet 125 may have an increased thickness in at least some areas, such as may aid in resisting abrasion and/or erosion caused by the solid particles during mixing operations. For example, a thickness 117 of the upper wall 115 may range between about nineteen millimeters and about thirty millimeters, a thickness 121 of the circumferential wall 120 may range between about 38 millimeters and about fifty millimeters, a maximum thickness 119 of the junction area 118 may range between about 65 millimeters and about eighty millimeters, a thickness 146 of the lower wall 145 may range between about nineteen millimeters and about forty millimeters, and the wall thickness 126 of the outlet 125 may range between about eighteen millimeters and about 41 millimeters. However, other dimensions are also within the scope of the present disclosure.

The casing 101 may further comprise one or more additional layers of material about its inner surface, thus forming a casing comprising inner and outer layers, wherein the inner layer may be aid in resisting abrasion and/or erosion caused by the solid particles during mixing operations. For example, the upper section 110 may comprise an upper inner layer 130 of material and the lower section 140 of the casing 101 may comprise a lower inner layer 150 of material, such that the upper wall 115, the circumferential wall 120, and the lower wall 145 may comprise the outer layer of the casing 101. The upper inner layer 130 may have a thickness 127 ranging between about five millimeters and about ten millimeters, and the lower inner layer 150 may have a thickness 128 ranging between about five millimeters and about ten millimeters.

The material forming the upper wall 115, the circumferential wall 120, and the lower wall 145 may comprise a first material, while the material forming the upper and lower inner layers 130, 150 may comprise a second material. The second material forming the inner layers 130, 150 may be resistant to abrasion, may be more resistant to abrasion than the first material, and/or may be substantially harder than the first material. The first material may have a hardness ranging between about 205 BHN and about 235 BHN, and the second material may have a hardness greater than about 600 BHN. The second material may also or instead comprise nanomaterial, such as may have a feature or character having at least one dimension that is less than about 100 nanometers. The upper inner layer 130 of the second material may be clad or welded onto the upper wall 115 and the circumferential wall 120 of the casing 101, and the lower inner layer 150 of the second material may be clad or welded onto the lower wall 145 of the casing 101. The inner layers 130, 150 of the second material may also or instead be formed with thermal spraying or hot melt coating, as described above.

As shown in FIGS. 3 and 4, the casing 101 may comprise several features, as described above. For example, the casing 101 may comprise the upper wall 115, the circumferential wall 120, and the lower wall 145 having the increased thickness. The casing 101 may comprise the upper and lower inner layers 130, 150 of material covering the upper wall 115, the circumferential wall 120, and the lower wall 145 of the casing 101. It should be understood, that the casing 101 may include one or more of the features depicted in FIGS. 3 and 4 and/or described above, while excluding one or more other features depicted in FIGS. 3 and 4 and/or described above. For example, the casing 101 may comprise the upper wall 115, the circumferential wall 120, and the lower wall 145 having the increased thickness, while excluding the upper and lower inner layers 130, 150 of material. Alternatively, the casing 101 may comprise the upper and lower inner layers 130, 150 of material covering the upper wall 115, the circumferential wall 120, and the lower wall 145, while excluding the upper wall 115, the circumferential wall 120, and the lower wall 145 having the increased thickness.

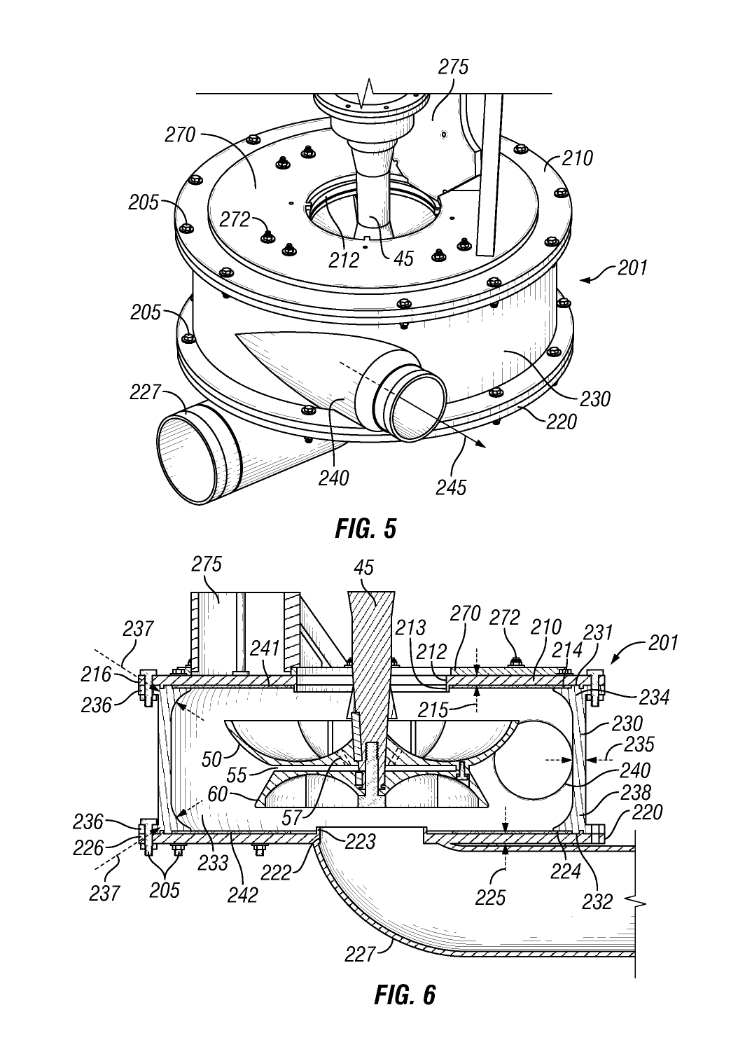

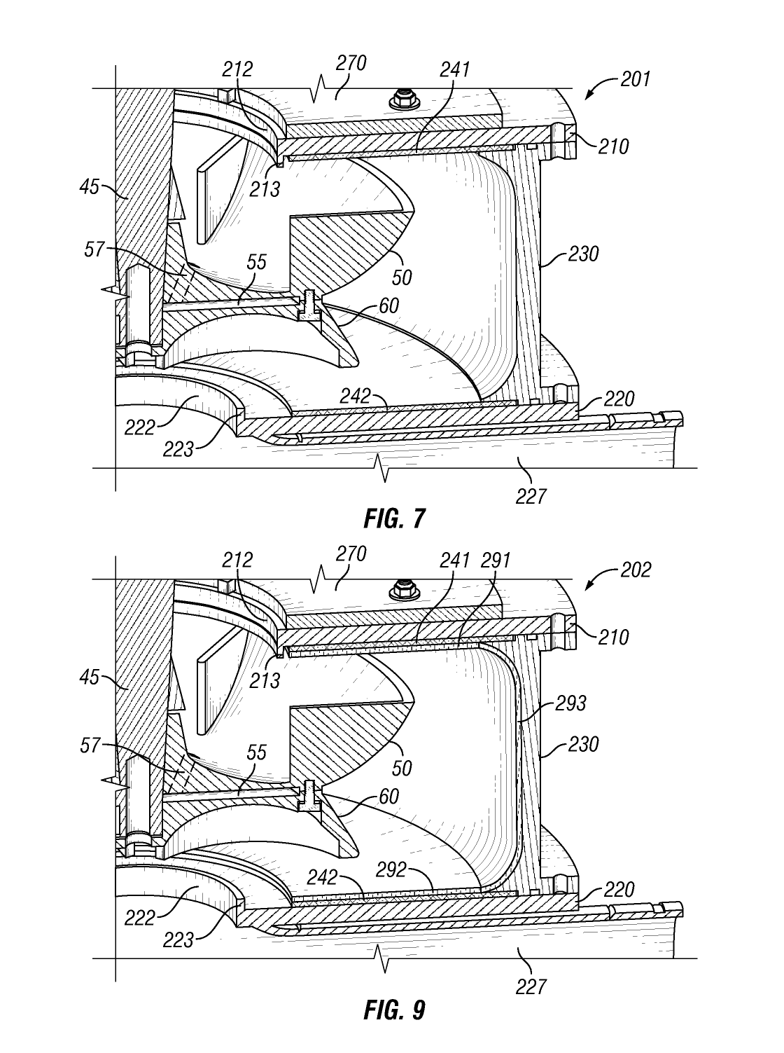

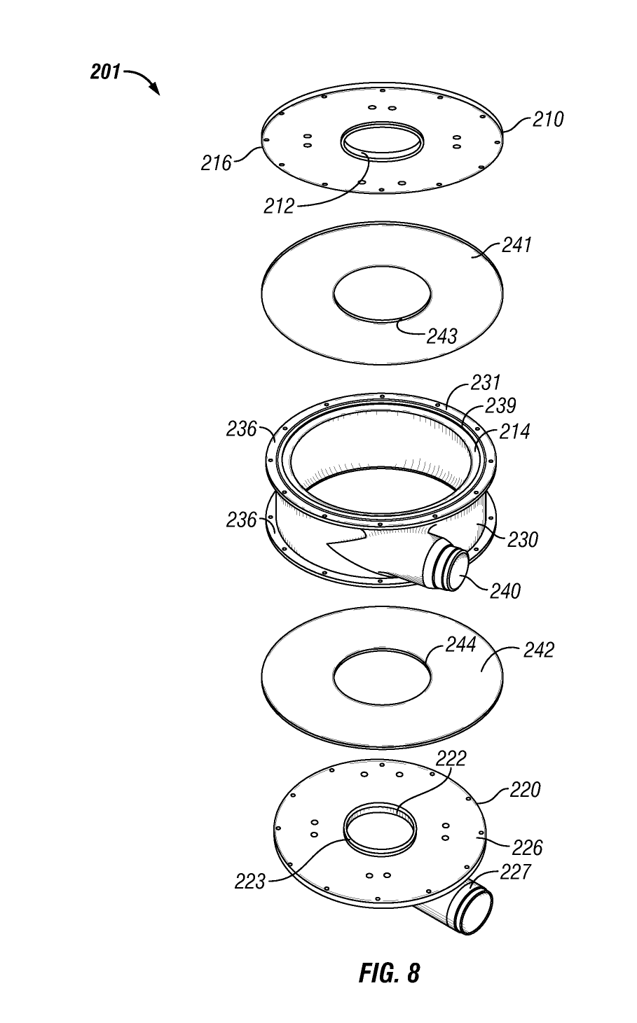

FIG. 5 is an isometric view of another example implementation of the casing 20 shown in FIGS. 1 and 2 according to one or more aspects of the present disclosure, designated herein by reference numeral 201. FIG. 6 is a sectional view of the casing 201 shown in FIG. 5. FIG. 7 is an enlarged sectional isometric view of the casing 201 shown in FIGS. 5 and 6. FIG. 8 is an exploded isometric view of the casing 201 shown in FIGS. 5-7. The following description refers collectively to FIGS. 5-8 and, where indicated by like reference numerals, FIG. 1.

The casing 201 comprises an upper section 210, a lower section 220, and an intermediate section 230 extending between the upper and lower sections 210, 220. The upper section 210 of the casing 201 comprises a substantially annular disc-shaped plate having a centrally located inlet opening 212, such as may be operably similar to the inlet opening 24 shown in FIG. 1. The inlet opening 212 may further comprise an integral or discrete sleeve or lip 213 extending about the inlet opening 212 and into the casing 201, such as may aid in directing the solid particle supply into the casing 201 and/or preventing unwanted escape of mixture through the inlet opening 212. The upper section 210 may also comprise a mounting plate 270 coupled thereto by one or more threaded fasteners 272 and/or other means. For example, the mounting plate 270 may be coupled with the upper section 210 of the casing 201 by a plurality of bolts extending between the mounting plate 270 and the upper section 210. The mounting plate 270 may be utilized for connection with the hopper 30 and/or the rotary drive 40, such as via the vertical supports 34, 44 shown in FIG. 1. For example, the mounting plate 270 may be connected with the hopper 30 and/or the rotary drive 40 via one or more vertical support members 275, the vertical supports 34, 44, and/or other support members.

The lower section 220 of the casing 201 is or comprises a substantially annular disc-shaped member having a centrally located inlet opening 222, such as may be operably similar to the fluid inlet 26 shown in FIG. 1. The inlet opening 222 may further comprise an integral or discrete sleeve or lip 223 extending about the inlet opening 222 and into the casing 201, such as may aid in directing the solid particle supply into the casing 201 and/or preventing unwanted escape of mixture through the inlet opening 222. The lower section 220 may further comprise or be coupled with an inlet conduit 227. The inlet conduit 227 may be operably similar to the inlet conduit 27 shown in FIG. 1. For example, the inlet conduit 227 may comprise a substantially tubular member extending between and fluidly connecting the casing 201 and the source of the fluid (not shown). One end of the inlet conduit 227 may be connected to a source of the fluid and the opposite end may be inserted into the inlet opening 222 or otherwise fluidly connected with the inlet opening 222, thus permitting the introduction of fluid into the casing 201.

The central section 230 of the casing 201 may be substantially cylindrical, having an upper surface 231 (or an upper edge), a lower surface 232 (or a lower edge), and an inner surface 233 extending between the upper and lower surfaces 231, 232. The inner surface 233 of the central section 230 may curve radially inward proximate the upper and lower surfaces 231, 232, such as to define upper and lower radial portions 234, 238 of the central section 230. The central section 230 further comprises an outlet 240, such as may be operably similar to the outlet 25 shown in FIGS. 1 and 2. The outlet 240 may comprise a substantially cylindrical or otherwise tubular member extending from the central section 230 at a substantially central location between the upper surface 231 and the lower surface 232.

The upper section 210 of the casing 201 may be coupled to the lower section 220 of the casing 201 via the central section 230 of the casing 201. The upper and lower sections 210, 220 may be fixedly coupled to the central section 230 with one or more threaded fasteners 205 and/or other means. For example, the upper and lower sections 210, 220 may be fixedly coupled to the central section 230 by a plurality of bolts, which may extend through flange portions 216, 226, 236 of the upper, lower, and central sections 210, 220, 230, respectively. When connected, the upper and lower sections 210, 220 of the casing 201 may be substantially concentric relative to each other.

One or more of the upper section 210, the central section 230, and the lower section 220 may comprise an increased thickness in at least some areas, such as may aid in resisting abrasion and/or erosion caused by the solid particles during mixing operations, which may increase the functional life of the casing 201. For example, a thickness 215 of the upper section 210 of the casing 201 may range between about twenty millimeters and about thirty millimeters, a wall thickness 235 of the central section 230 of the casing 201 may range between about fifteen millimeters and about twenty millimeters, a thickness 225 of the lower section 220 may range between about twenty millimeters and about thirty millimeters, and a maximum thickness 237 of the radial portions 234, 238 of the central section 230 may range between about forty millimeters and about seventy millimeters. However, other dimensions are also within the scope of the present disclosure.

The casing 201 may also comprise one or more additional layers of material about one or more inner surfaces, such as to form a casing 201 comprising inner and outer layers, wherein the inner layer may aid in resisting abrasion and/or erosion caused by the solid particles during mixing operations. For example, the inner layers of the casing 201 may comprise an upper wear plate 241 covering the inner side of the upper section 210 and a lower wear plate 242 covering the inner side of the lower section 220, such that the upper and lower sections 210, 220 may be considered as the upper and lower outer layers of the casing 201. The upper and lower wear plates 241, 242 may each be or comprise a substantially annular disc-shaped member with respective centrally located openings 243, 244 extending therethrough. The thickness of the upper and lower wear plates 241, 242 may range between about five millimeters and about ten millimeters, although other dimensions are also within the scope of the present disclosure.

The upper and lower wear plates 241, 242 may be detachably disposed against the upper section 210 and the lower section 220, respectively. Accordingly, the upper and lower wear plates 241, 242 may be field replaceable, such as to permit the wear plates 241, 242 to be removed and replaced utilizing standard tools and/or at the general site or location where the mixing operations are conducted.

The upper wear plate 241 may be retained between the upper section 210 of the casing 201 and the upper surface 231 of the central section 230 of the casing 201, such as to cover the inner surface of the upper section 210. The lower wear plate 242 may be retained between the lower section 220 and the lower surface 232 of the central section 230, such as to cover the inner surface of the lower section 220. Grooves 239 in the upper and lower surfaces 231, 232 of the central section 230 and/or grooves (not shown) in the upper and/or lower sections 210, 220 may be sized to receive at least a portion of the upper and lower wear plates 241, 242. The upper section 210, the lower plate 221, and the central section 230 may be coupled together to form a seal therebetween, such as may be operable to prevent the solid particles and/or the fluid from escaping from within the casing 201 into the external atmosphere during mixing operations.

The upper, lower, and central sections 210, 220, 230 of the casing 201 may comprise a first material, and the upper and lower wear plates 241 242 may comprise a second material. The first and the second material may be the same or different. For example, the second material may be resistant to abrasion, may be more resistant to abrasion than the first material, and/or may be substantially harder than the first material. For example, the first material may have a hardness ranging between about 205 BHN and about 235 BHN, and the second material may have a hardness greater than about 600 BHN. The second material may also or instead comprise nanomaterial, such as may have a feature or character having at least one dimension that is less than about 100 nanometers.

FIG. 9 is an isometric sectional view of another implementation of the casing 200 shown in FIG. 7, herein designated by the reference numeral 202. In addition to (or instead of) the wear plates 241, 242 shown in FIG. 7, the upper section 210 may also comprise an upper overlay 291 and the lower section 220 may also comprise a lower overlay 292. The central section 230 may also comprise a central overlay 293. Collectively, the upper, lower, and central overlays 291, 292, 293 may cover substantial portions of the inner surfaces of the upper, lower, and central sections 210, 220, 230 of the casing 201 and/or of the upper and lower wear plates 241, 242 to, for example, further aid in protecting the upper section 210, the lower plate 221, and the central section 230 from abrasion and/or erosion caused by the solid particles during mixing operations. For example, the overlays 291, 292, 293 may be formed by cladding, thermal spraying, hot melt coating, welding as described above, and/or by any other means know in the art. The thickness of the upper, lower, and central overlays 291, 292, 293 may range between about five millimeters and about ten millimeters, although other dimensions are also within the scope of the present disclosure. The overlays 291, 292, 293 may comprise the second material as described above.

The casing 201 and/or the casing 202 shown in FIGS. 5-9 may include one or more of the features depicted in FIGS. 5-9 and/or described above while excluding one or more other features depicted in FIGS. 5-9 and/or described above. For example, the casing 201 and/or the casing 202 may exclude the wear plates 241, 242 and the upper, lower, and central overlays 291, 292, 293. However, the casing 201 and/or the casing 202 may instead include the wear plates 241, 242 but not the upper, lower, and central overlays 291, 292, 293. Similarly, the casing 201 and/or the casing 2020 may include the upper and lower wear plates 241, 242 and the central weld overlay 293 but not the upper and lower overlays 291, 292. The casing 201 and/or the casing 202 may also include the upper, lower, and central overlays 291, 292, 293 but not the wear plates 241, 242. Other combinations are also within the scope of the present disclosure, including with features depicted in one or more of FIGS. 1-4 and/or otherwise described herein.

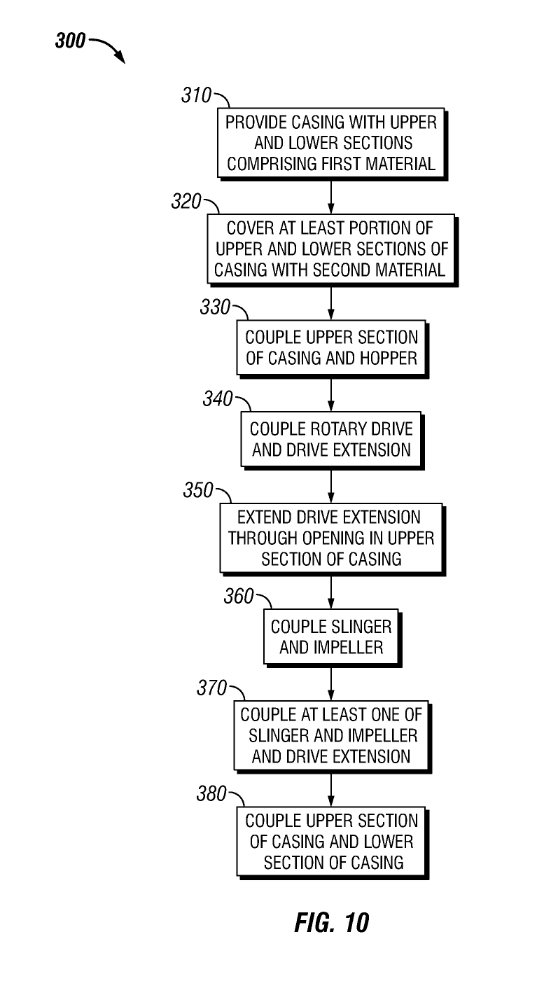

With continued reference to FIGS. 1-9 where indicated by like reference numerals, FIG. 10 is a flow-chart diagram of at least a portion of an example implementation of a method (300) of manufacturing and/or assembling a mixing apparatus according to one or more aspects of the present disclosure. The method (300) may comprise providing (310) a casing 20, 101, 201, 202 comprising an upper section 21, 110, 210 and a lower section 22, 140, 220. The upper and lower sections may comprise a first material, such as the above-described material forming sections/walls 21, 22, 115, 120, 145, 210, 221, 230 of the casing.

At least portions of each of the upper and lower sections of the casing may also be covered (320) with a second material, such as the above-described material forming the inner layers 28, 29, 130, 150, 241, 242, 291, 292 of the casing. Next, the upper section of the casing and a hopper 30 may be coupled (330) together, such that the upper section is disposed below the hopper. The rotary drive 40 and a drive extension 45, 265 may then be coupled (340) together, and the drive extension may be extended (350) through an opening 24, 114, 212 in the upper section of the casing. Thereafter, a slinger 50, 250 and an impeller 60, 260 may be coupled (360) together, such that the impeller is disposed below the slinger, and at least one of the slinger and the impeller may be coupled (370) with the drive extension. The upper section of the casing and the lower section of the casing may then be coupled (380) to enclose the slinger and the impeller within the casing.

As described above, the second material may be substantially harder than the first material, the second material may be substantially more resistant to abrasion than the first material, and/or a feature or character of the second material may have a dimension less than about 100 nanometers. Covering (320) at least portions of each of the upper and lower sections of the casing with the second material may comprise welding or cladding the second material onto the upper and lower sections of the casing.

As described above, the casing may comprise an upper and lower wear plates 241, 242, such as may aid in reducing abrasion and/or erosion caused by the solid particles during mixing operations. Therefore, covering (320) at least portions of each of the upper and lower sections of the casing with the second material may comprise covering a substantial portion of the inner surface of the upper section of the casing with an upper wear plate substantially comprising the second material, and covering a substantial portion of the inner surface of the lower section of the casing with a lower wear plate substantially comprising the second material.

As also described above, the casing may comprise a central section 230, such as may be operable to couple together the upper 210 and lower 220 sections of the casing 201. Accordingly, coupling (380) the upper section 210 of the casing 201 and the lower section 220 of the casing 201 to enclose the slinger 250 and the impeller 260 within the casing 201 may comprise coupling the central section 230 of the casing 201 and the upper section 210 of the casing 201 and coupling the central section 230 of the casing and the lower section 220 of the casing to enclose the slinger 250 and the impeller 260 within the casing 201.

In such implementations, among others within the scope of the present disclosure, the wear plates may be positioned between the central section 230 and each of the upper and lower sections 210, 220 of the casing 201. Therefore, covering (320) at least portions of each of the upper and the lower sections of the casing with the second material may comprise disposing an upper wear plate 241 between the upper section 210 of the casing 201 and the central section 230 of the casing 201, wherein the upper wear plate 241 substantially comprises the second material, and disposing a lower wear plate 242 between the lower section 220 of the casing 201 and the central section 230 of the casing 201, wherein the lower wear plate 242 also substantially comprises the second material.

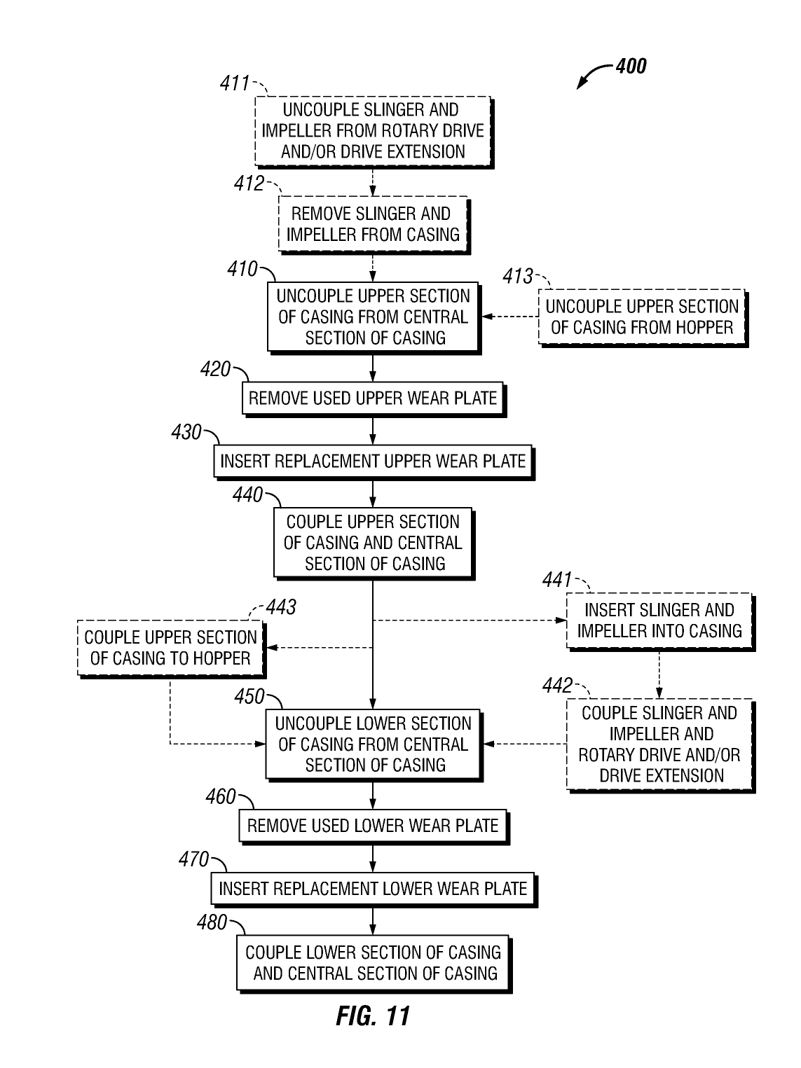

With continued reference to FIGS. 1-9 where indicated by like reference numerals, FIG. 11 is a flow-chart diagram of at least a portion of an example implementation of a method (400) of replacing portions of a mixing apparatus according to one or more aspects of the present disclosure. The method (400) may comprise replacing a used wear plate 241 by uncoupling (410) an upper section 210 of a casing assembly 201 from a central section 230 of the casing assembly, removing (420) the used upper wear plate 241 from between the upper section 210 of the casing assembly 201 and the central section 230 of the casing assembly 201, inserting (430) a replacement upper wear plate between the upper section 220 of the casing assembly 201 and the central section 230 of the casing assembly 201, and recoupling (440) the upper section 210 of the casing assembly 201 and the central section 230 of the casing assembly 201.

The method (400) may further comprise replacing a used lower wear plate 242 by uncoupling (450) a lower section 220 of the casing assembly 201 from the central section 230 of the casing assembly 201, removing (460) the used lower wear plate 242 from between the lower section 220 of the casing assembly 201 and the central section 230 of the casing assembly 201, inserting (470) a replacement lower wear plate between the lower section 220 of the casing assembly 201 and the central section 230 of the casing assembly 201, and recoupling (480) the lower section 220 of the casing assembly 201 and the central section 230 of the casing assembly 201.

Each of the upper and lower sections 210, 220 may comprise the above-described first material, and each of the used and/or replacement upper and lower wear plates 241, 242 may comprise the above-described second material. As described above, the second material may be substantially harder than the first material, the second material may be substantially more resistant to abrasion than the first material, and/or a feature or character of the second material may have a dimension less than about 100 nanometers.

The method (400) may further comprise uncoupling (411) the slinger 250 and the impeller 260 from a rotary drive 40 and/or drive extension 45 before uncoupling (410) the upper section 210 of a the casing 201 from the central section 230, then removing (412) the slinger 250 and the impeller 260 from the casing 201. In such implementations, among others within the scope of the present disclosure, after coupling (440) the upper section 210 of the casing 201 and the central section 230 of the casing 201, the method (400) may further comprise inserting (441) the slinger 250 and the impeller 260 into the casing assembly 201, and then coupling (442) the slinger 250 and the impeller 260 with the rotary drive 40 and/or drive extension 45.

The method (400) may further comprise uncoupling (413) the upper section 210 of the casing 201 from a hopper 30 before uncoupling (410) the upper section 210 from the central section 230, and then coupling (443) the upper section 210 to the hopper 30 after coupling (440) the upper section 210 and the central section 230.

Other variations of the method (400) are also within the scope of the present disclosure. For example, coupling/uncoupling the upper section of the casing and the hopper may be performed in an order other than as shown in FIG. 11, as well as coupling/uncoupling and removing/inserting the slinger and impeller relative to the rotary drive, drive extension, and casing.

In view of the entirety of the present disclosure, including the figures and the claims below, a person having ordinary skill in the art will readily recognize that the present disclosure introduces an apparatus comprising: a casing having an outer layer and an inner layer; a hopper for delivering bulk solids into the casing; a rotary drive disposed external to the casing; a slinger suspended for rotation within the casing via a drive extension extending from the rotary drive into the casing; an impeller coupled with the slinger within the casing; an inlet for delivering fluid into the casing; and an outlet for discharging a mixture of the bulk solids and the fluid from the casing.

The outer layer may comprise a first material, and the inner layer may comprise a second material. The second material may be substantially more resistant to abrasion than the first material. The second material may be substantially harder than the first material. The first material may have a hardness ranging between about 205 BHN and about 235 BHN, and the second material may have a hardness greater than about 600 BHN. A feature or character of the second material may have a dimension less than about 100 nanometers. The inner layer of the second material may be welded or clad onto the outer layer of the first material.

The inner and outer layers may be welded together.

A thickness of the inner layer may range between about two millimeters and about seven millimeters.

The casing and at least a portion of the inner layer may be detachably coupled.

The casing may further comprise an upper section located above the slinger, a lower section located below the impeller, and a central section extending between the upper and lower sections. The inner layer of each of the upper and lower sections may be field-replaceable.

The casing may comprise: an upper section; a lower section; a central section; an upper wear plate disposed between the upper section and the central section; and a lower wear plate disposed between the lower section and the central section. The outer layer may comprise the upper and lower covers, and the inner layer may comprise the upper and lower wear plates. The upper and lower wear plates may each be detachably coupled with the casing. The central section may comprise an upper contact surface and a lower contact surface, the upper wear plate may be disposed between the upper section and the upper contact surface of the central section, and the lower wear plate may be disposed between the lower section and the lower contact surface of the central section. The central section may be substantially cylindrical and comprise an upper edge, a lower edge, and an inner surface, wherein the inner surface may curve radially inward adjacent the upper edge, and wherein the inner surface may curve radially inward adjacent the lower edge. The central section may be substantially cylindrical and comprise an upper edge, a lower edge, and a wall extending between the upper edge and the lower edge, and the outlet may be substantially centrally positioned between the upper and lower edges.

The present disclosure also introduces a method comprising: assembling a mixing apparatus by: providing a casing comprising an upper section and a lower section, wherein the upper and lower sections comprise a first material; covering at least portions of each of the upper and lower sections of the casing with a second material; coupling the upper section of the casing and a hopper, wherein the upper section is disposed below the hopper; coupling a rotary drive and a drive extension; extending the drive extension through an opening in the upper section of the casing; coupling a slinger and an impeller, wherein the impeller is disposed below the slinger; coupling at least one of the slinger and impeller and the drive extension; and coupling the upper section of the casing and the lower section of the casing to enclose the slinger and the impeller within the casing.

The second material may be substantially harder than the first material.

The second material may be substantially more resistant to abrasion than the first material.

A feature or character of the second material may have a dimension less than about 100 nanometers.

Covering at least portions of each of the upper and the lower sections of the casing with the second material may comprise welding or cladding the second material onto the upper and lower sections of the casing.

Covering at least portions of each of the upper and the lower sections of the casing with the second material may comprise: covering a substantial portion of the inner surface of the upper section of the casing with an upper wear plate substantially comprising the second material; and covering a substantial portion of the inner surface of the lower section of the casing with a lower wear plate substantially comprising the second material.

Coupling the upper section of the casing and the lower section of the casing to enclose the slinger and the impeller within the casing may comprise: coupling a central section of the casing and the upper section of the casing; and coupling the central section of the casing and the lower section of the casing to enclose the slinger and the impeller within the casing. Covering at least portions of each of the upper and the lower sections of the casing with the second material may comprise: disposing an upper wear plate between the upper section of the casing and the central section of the casing, wherein the upper wear plate may substantially comprise the second material; and disposing a lower wear plate between the lower section of the casing and the central section of the casing, wherein the lower wear plate may substantially comprise the second material.

The present disclosure also introduces a method comprising: replacing portions of a mixing apparatus by: uncoupling an upper section of a casing from a central section of the casing; removing a used upper wear plate from between the upper section of the casing and the central section of the casing; inserting a replacement upper wear plate between the upper section of the casing and the central section of the casing; coupling the upper section of the casing and the central section of the casing; uncoupling a lower section of the casing from the central section of the casing; removing a used lower wear plate from between the lower section of the casing and the central section of the casing; inserting a replacement lower wear plate between the lower section of the casing and the central section of the casing; and coupling the lower section of the casing and the central section of the casing.

The upper and lower sections may each substantially comprise a first material, and the replacement upper and lower wear plates may each substantially comprise a second material. The second material may be substantially harder than the first material. The second material may be substantially more resistant to abrasion than the first material.

The upper and lower sections of the casing and the first upper and lower wear plates may be substantially annular disc-shaped.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same uses and/or achieving the same benefits of the embodiments introduced herein. A person having ordinary skill in the art should also realize that such equivalent constructions do not depart from the scope of the present disclosure, and that they may make various changes, substitutions and alterations herein without departing from the spirit and scope of the present disclosure.

The Abstract at the end of this disclosure is provided to comply with 37 C.F.R. §1.72(b) to permit the reader to quickly ascertain the nature of the technical disclosure. It is submitted with the understanding that it will not be used to interpret or limit the scope or meaning of the claims.

What is claimed is:

1. An apparatus, comprising:
a casing having an outer layer and an inner layer;
a hopper for delivering bulk solids into the casing;
a rotary drive disposed external to the casing;
a slinger suspended for rotation within the casing via a drive extension extending from the rotary drive into the casing;
an impeller coupled with the slinger within the casing;
an inlet for delivering fluid into the casing; and
an outlet for discharging a mixture of the bulk solids and the fluid from the casing.

2. The apparatus of claim 1 wherein the outer layer comprises a first material and the inner layer comprises a second material.

3. The apparatus of claim 2 wherein the second material is substantially more resistant to abrasion than the first material.

4. The apparatus of claim 2 wherein the second material is substantially harder than the first material.

5. The apparatus of claim 2 wherein the first material has a hardness ranging between about 205 BHN (Brinell Hardness Number) and about 235 BHN, and wherein the second material has a hardness greater than about 600 BHN.

6. The apparatus of claim 2 wherein a feature or character of the second material has a dimension less than about 100 nanometers.

7. The apparatus of claim 2 wherein the inner layer of the second material is welded or clad onto the outer layer of the first material.

8. The apparatus of claim 1 wherein the casing and at least a portion of the inner layer are detachably coupled.

9. The apparatus of claim 1 wherein the casing further comprises an upper section located above the slinger, a lower section located below the impeller, and a central section extending between the upper and lower sections, wherein the inner layer of each of the upper and lower sections is field-replaceable.

10. The apparatus of claim 1 wherein the casing comprises:
an upper section;
a lower section;
a central section;
an upper wear plate disposed between the upper section and the central section; and
a lower wear plate disposed between the lower section and the central section;
wherein the outer layer comprises the upper and lower covers, and wherein the inner layer comprises the upper and lower wear plates.

11. The apparatus of claim 10 wherein the upper and lower wear plates are each detachably coupled with the casing.

12. The apparatus of claim 10 wherein the central section comprises an upper contact surface and a lower contact surface, wherein the upper wear plate is disposed between the upper section and the upper contact surface of the central section, and wherein the lower wear plate is disposed between the lower section and the lower contact surface of the central section.

13. A method, comprising:
assembling a mixing apparatus by:
providing a casing comprising an upper section and a lower section, wherein the upper and lower sections comprise a first material;
covering at least portions of each of the upper and lower sections of the casing with a second material;
coupling the upper section of the casing and a hopper, wherein the upper section is disposed below the hopper;
coupling a rotary drive and a drive extension;
extending the drive extension through an opening in the upper section of the casing;
coupling a slinger and an impeller, wherein the impeller is disposed below the slinger;
coupling at least one of the slinger and impeller and the drive extension; and
coupling the upper section of the casing and the lower section of the casing to enclose the slinger and the impeller within the casing.

14. The method of claim 13 wherein the second material is substantially more resistant to abrasion than the first material.

15. The method of claim 13 wherein covering at least portions of each of the upper and the lower sections of the casing with the second material comprises welding or cladding the second material onto the upper and lower sections of the casing.

16. The method of claim 13 wherein covering at least portions of each of the upper and the lower sections of the casing with the second material comprises:
covering a substantial portion of the inner surface of the upper section of the casing with an upper wear plate substantially comprising the second material; and
covering a substantial portion of the inner surface of the lower section of the casing with a lower wear plate substantially comprising the second material.

17. The method of claim 13 wherein coupling the upper section of the casing and the lower section of the casing to enclose the slinger and the impeller within the casing comprises:
coupling a central section of the casing and the upper section of the casing; and
coupling the central section of the casing and the lower section of the casing to enclose the slinger and the impeller within the casing.

18. The method of claim 17 wherein covering at least portions of each of the upper and the lower sections of the casing with the second material comprises:
disposing an upper wear plate between the upper section of the casing and the central section of the casing, wherein the upper wear plate substantially comprises the second material; and
disposing a lower wear plate between the lower section of the casing and the central section of the casing, wherein the lower wear plate substantially comprises the second material.

19. A method, comprising:
replacing portions of a mixing apparatus by:
uncoupling an upper section of a casing from a central section of the casing;
removing a used upper wear plate from between the upper section of the casing and the central section of the casing;
inserting a replacement upper wear plate between the upper section of the casing and the central section of the casing;
coupling the upper section of the casing and the central section of the casing;
uncoupling a lower section of the casing from the central section of the casing;
removing a used lower wear plate from between the lower section of the casing and the central section of the casing;
inserting a replacement lower wear plate between the lower section of the casing and the central section of the casing; and
coupling the lower section of the casing and the central section of the casing.

20. The method of claim 19 wherein the upper and lower sections each substantially comprise a first material, wherein the replacement upper and lower wear plates each substantially comprise a second material, and wherein the second material is substantially harder than the first material.
